(19) United States
(12) Patent Application Publication
(10) Pub. No.: US 2006/0136358 A1
(43) Pub. Date: Jun. 22, 2006

(54) Database tuning advisor graphical tool

(75) Inventors: Dmitry Sonkin, Redmond, WA (US); Maciej Sarnowicz, Redmond, WA (US); Bruce A. Prang, Woodinville, WA (US); Djana Ophelia Clay Milton, Lakewood, WA (US); Arunprasad P. Marathe, Redmond, WA (US); Vivek R. Narasayya, Redmond, WA (US); Manoj A. Syamala, Redmond, WA (US); Sanjay Agrawal, Kirkland, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/019,335

(22) Filed: Dec. 21, 2004

(51) Int. Cl. H04N 5/44

(52) U.S. Cl. 707/1

(57) ABSTRACT

An automated database tuning tool may include a user interface component and a tuning engine. The user interface may be a graphical component that interfaces with a user to collect configuration parameters for a tuning session for a specified database. The configuration parameters may be stored in a tuning database. A tuning engine that performs the actual tuning process may generate physical design recommendations and reports. The recommendations and reports may be stored in the tuning database, enabling the tuning tool to be run off-line or in background. Communication between components of the tuning tool may occur via stored procedures.

### CROSS-REFERENCE TO RELATED APPLICATIONS

This application is related to U.S. patent application Ser. No. 10/966,282, Attorney Docket No. MSFT-4462/309454.01 filed Oct. 15, 2004 entitled “Schema For Physical Database Tuning” and U.S. patent application Ser. No. 10/966,563, Attorney Docket No. MSFT-4463/309453.01 entitled “Database Tuning Advisor”, filed Oct. 15, 2004.

### FIELD OF THE INVENTION

The invention relates to database tuning and in particular to communication mechanisms within a database tuning tool.

### BACKGROUND OF THE INVENTION

The performance of a database system can depend to a large extent on physical design features such as indexes, indexed views and horizontal partitioning. A number of automated tools have emerged over the past several years that are intended to help to reduce the burden on the database administrator (DBA) by helping to determine an appropriate physical design for a database. Known tools do not, however, provide the ability to perform off-line tuning, to monitor tuning session progress, to cancel or abort sessions or to clone previously tuned sessions for iterative submissions to the tuning tool.

It would be helpful if a tool were available that addresses the above-listed short-comings.

### SUMMARY OF THE INVENTION

An automated database tuning tool may include a user interface component and a tuning engine. The user interface may be a graphical component that interfaces with a user to collect configuration parameters for a tuning session for a specified database or databases. The configuration parameters may be stored in a tuning database. A tuning engine that performs the actual tuning process may generate physical design recommendations and reports. The recommendations and reports may be stored in the tuning database, enabling the tuning tool to be scheduled to run off-line or in background.

A communication mechanism between the two components of the database tuning system may utilize a set of modularized stored procedures. Stored procedures may include one or more of the following: a procedure to initiate a tuning session, a procedure to change aspects of the tuning session, a procedure to delete a tuning session, a procedure to retrieve tuning session results, a procedure to retrieve tuning session reports and a procedure to provide detailed information about a single tuning session or about multiple tuning sessions. Communications and results may be in the form of XML or other language capable of capturing complex hierarchical information.

All or portions of the tuning tool may reside on and be executed on a server but may be initiated by a client. Portions of the tuning tool may reside on one or more clients. Once initiated, the progress of the tuning session may be monitored via the interface and the results and reports generated by the tuning session may be viewed by one or more clients by accessing the server. The communications between client and server may occur via the stored procedures described above.

The configuration parameters stored in the tuning database for an executed tuning session may be accessed and may be used to initiate a second tuning session. This process is referred to herein as cloning a tuning session. Similarly, the stored configuration parameters for an executed tuning session may be accessed, modified and the modified configurations may be used to clone a session.

Tuning results may be stored in a database. The tuning session may execute off-line or in background. Results and reports may be accessed at any time after termination or completion of the tuning session by one or more clients.

### BRIEF DESCRIPTION OF THE DRAWINGS

The foregoing summary, as well as the following detailed description of illustrative embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented;

FIG. 2 is a block diagram of a system for database performance and manageability tuning in accordance with one embodiment of the invention;

FIG. 3 is a block diagram of a system for database performance and manageability tuning that uses a graphical user interface in accordance with the invention;

FIG. 4 is a flow diagram of a method for database tuning in accordance with one embodiment of the invention; and

FIG. 5 is an exemplary display or report that may be generated in accordance with one embodiment of the invention.

### DETAILED DESCRIPTION OF ILLUSTRATIVE EMBODIMENTS

Overview

A database tuning advisor as described in U.S. patent application Ser. Nos. 10/966,282 and 10/966,563 may provide an integrated physical design recommendation, eliminating or reducing the need for a DBA to make ad-hoc decisions such as how to stage tuning and how to divide up the overall storage to allocate for each step in the staged solution and so on. In accordance with some embodiments of the invention, a user interface component may provide a convenient means to establish configuration parameters for a tuning session, update the configuration parameters if desired, initiate a tuning session, monitor the tuning session, control the tuning session, and use the configuration parameters of a tuned session to create a new session and so on. In some embodiments of the invention, a tuning session is initiated via the user interface. Once the tuning session is initiated, the user interface may be closed. In some embodiments of the invention, a tuning session is scheduled via the user interface, through an agent. Because configuration parameters are stored in a tuning database, once the session is scheduled, the user interface that scheduled the session may be closed, and the session may run off-line (in background), when triggered. The progress of the tuning session may be monitored and controlled. Upon termination of a session, the configuration parameters of the session may be used to clone another session. The configuration parameters may be used “as is” or may be modified through the user interface.

Exemplary Computing Environment

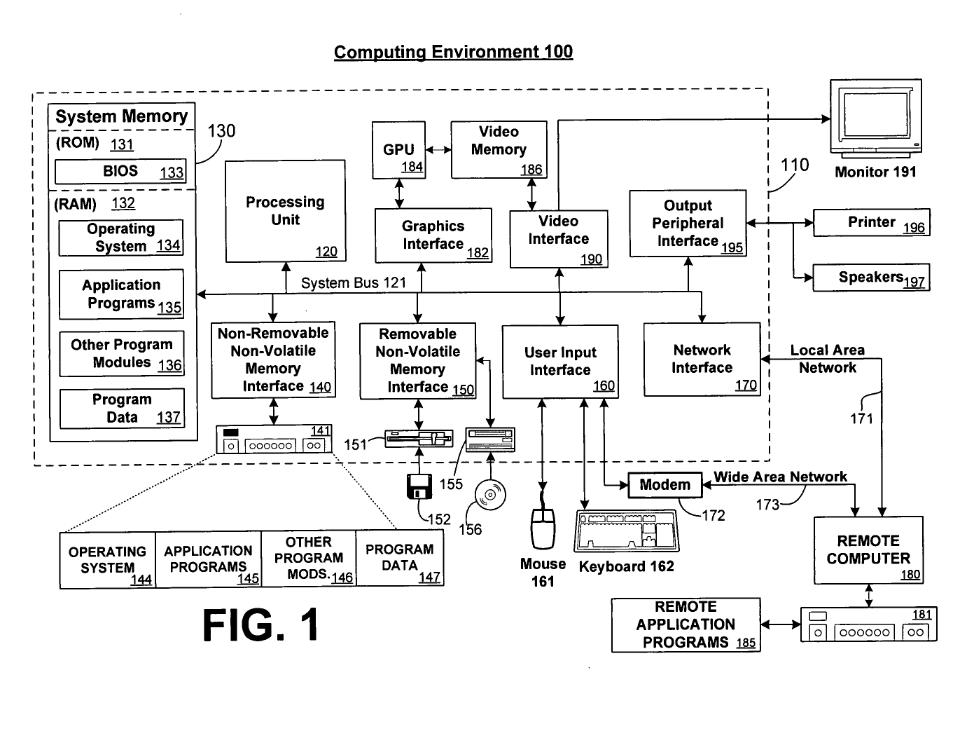

FIG. 1 and the following discussion are intended to provide a brief general description of a suitable computing environment in which the invention may be implemented. It should be understood, however, that handheld, portable, and other computing devices of all kinds are contemplated for use in connection with the present invention. While a general purpose computer is described below, this is but one example, and the present invention requires only a thin client having network server interoperability and interaction. Thus, the present invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

Interface to a Database Tuning Tool

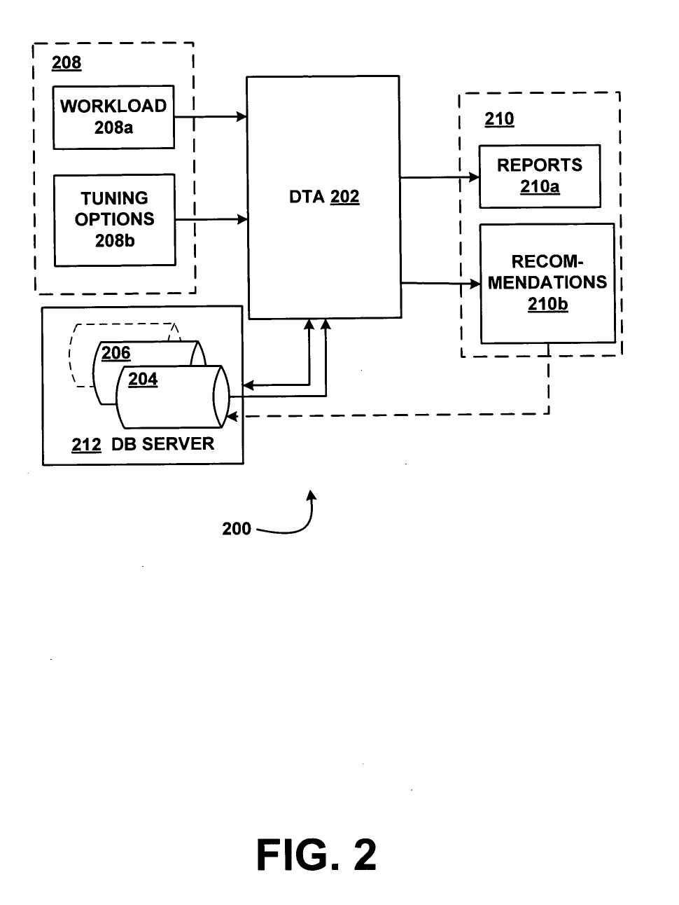

FIG. 2 is a block diagram of an exemplary system for tuning a database for performance and manageability in accordance with one embodiment of the invention. System 200 may reside on one or more computers, each of which may be a computer such as computer 110 described above with respect to FIG. 1.

System 200 may include one or more of the following components: a database tuning tool 202, one or more database(s) to be tuned or referenced 204, 206, etc., input 208 and output 210. Databases 204, 206, etc. may also be input to the database tuning tool 202. A database tuning tool may be invoked via a command line executable, a user interface or by other suitable means.

Database tuning tool 202 in some embodiments of the invention is a database tuning advisor for client physical design tuning. In some embodiments of the invention, it may be invoked from a user interface (e.g., a graphical user interface) or from a command-line executable. Database tuning tool 202 may reside on one or more test or production (database) servers.

Input 208 may include one or more databases (e.g., database 204, database 206, etc.), which typically reside on one or more separate servers, such as database server 212, although the invention is not so limited. Input 208 may also include a workload 208 a to tune. A workload may include a set of statements that may execute against the database server. The statements of the workload may be written in a language for creating, updating and, querying relational database management systems, such as SQL, TSQL, etc. One or more of the statements in the workload may be associated with a weight representing the relative importance of the statement to the performance of the database system. A workload may be a file including an organization or industry benchmark, may be obtained from a profiling tool or may be generated in any suitable way.

Input 208 may include tuning options 208b. Tuning options as used herein are broadly defined to include one or more of: a feature to be tuned, an alignment constraint, a partial physical configuration (e.g., a clustered index on a table, partitioning of a table or indexed view may be specified as “required”), a storage constraint (e.g., an upper bound of storage consumption), a time constraint, a logging condition and so on. Exemplary but non-limiting tuning options are discussed more fully below.

Output 210 may include one or more reports 210a and a physical design recommendation 210b. Physical design recommendation 210b may include a recommendation to create one or more indexes and indexed views. The output 210b may also include a recommendation to partition tables, indexes and indexed views. The output 210 may also include dropping existing physical design structures.

The database tuning advisor 202 may produce a set of reports 210a that describe usage of databases, tables, and columns. In particular, a “Database usage report” is an exemplary report that may show the count and percentage of queries in the workload that reference a particular database. Similarly, a “Table usage” and “Column Usage” report are exemplary reports that may show the count and percentage of queries in the workload that reference a particular table or column. These reports may be useful to a DBA for identification of frequently accessed objects on the server. In some embodiments of the invention, these reports are generated in XML.

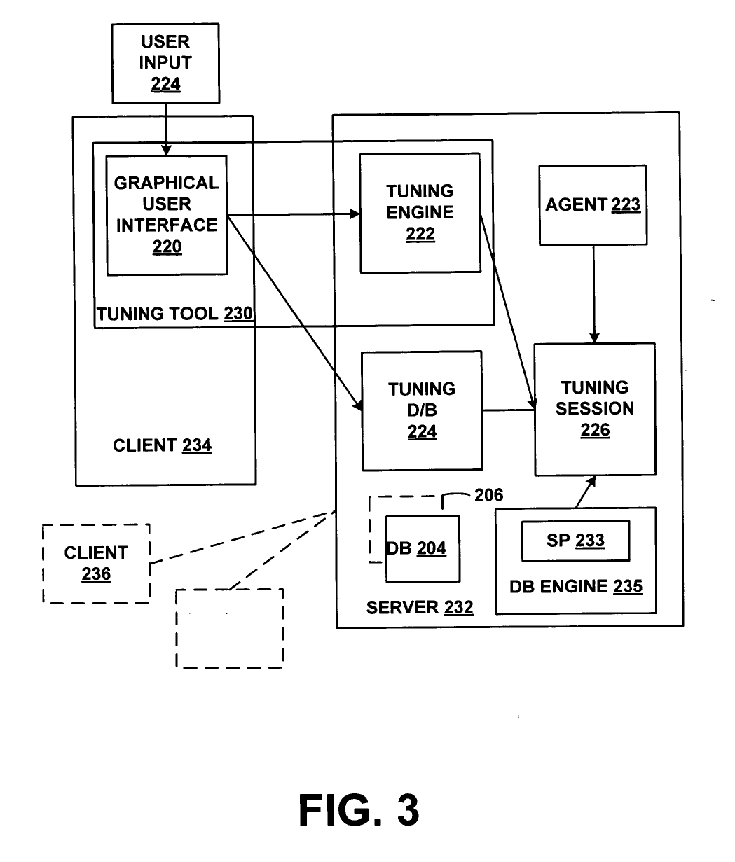

FIG. 3 illustrates an exemplary database tuning tool 230 such as database tuning advisor 202. The database tuning tool (e.g., database tuning advisor 202) may comprise one or more components including a command line utility (not shown) and/or a user interface (e.g., graphical user interface 220) and a database tuning engine 222. The database tuning tool 230 may reside on a server (such as but not limited to SQL server) or on one or more client computers such as client 234, 236, etc. or on both server and client computers. The tuning session process may be initiated via user interface 220 resident on a client computer and may execute on a server computer such as server 232. The executing tuning session (e.g., tuning session 226) may be accessed by the initiating client 234 and one or more non-initiating client computers (clients 236, etc.).

In some embodiments a command line utility and/or user interface 220 may receive configuration parameters and/or other information associated with the tuning session from a user (e.g., from user input 224) and may initiate a tuning session 226. User input 224 may include one or more databases to be tuned (e.g., databases 204, 206, etc.). Once the tuning session is initiated, the user interface may be closed and the session may run in background (off-line) on the server computer. As the session runs, the tuning database may be updated with information generated by the tuning session.

In some embodiments a command line utility and/or user interface 220 may receive configuration parameters and/or other information associated with the tuning session from a user (e.g., from user input 224) and store the configuration parameters in a database (e.g., tuning database 224) on the server 232. The tuning session 226 may be scheduled to run at a later time via the user interface 220, through an agent 223. The agent 223 may initiate the tuning session in response to a trigger. In some embodiments of the invention, a unique session identification number is generated and is passed to the database tuning engine 222 which in response starts the tuning session.

In some embodiments of the invention, some or all of the configuration parameters and associated information may be stored in metadata tables in the tuning database 224. The configuration parameters and associated information may be stored in the form of XML (eXtensible Markup Language) statements or by statements in any other suitable language.

The progress of the tuning session may be monitored via the graphical user interface 220. The session 226 may be stopped or cancelled. In some embodiments stopping/canceling the session means ending the tuning session 226. The information gathered prior to termination and stored in the tuning database 224 may however, be retained and may be used to generate the tuning recommendations and reports. The session 226 may be deleted. In some embodiments, deleting the session may terminate the tuning process without saving the information gathered prior to the termination of the session. The configuration parameters stored in the tuning database 224 may likewise be removed, discarded or erased.

The configuration parameters stored in the tuning database 224 for a tuning session that has already been performed (referred to herein as an executed tuning session) may be used to initiate a new session. This process is referred to herein as “cloning a session”. The configuration parameters may be used “as is” or may be modified. When a session is cloned, all input information, (e.g., tuning parameters and so on as described above), from an existing session is retrieved, an internal copy of the input information is created in memory and the internal memory copy is submitted to the tuning engine to initiate a new session.

In some embodiments of the invention, modularized stored procedures are used to perform the above-described functions. In some embodiments stored procedures 233 comprise a portion of the database engine 235. Alternatively, the stored procedures may be stored elsewhere on the server computer. For example, in some embodiments of the invention, a stored procedure for initiating a session may be:

```
sp_dta_add_session
    @SessionName,  - name of the session nchar[30]
    @TuningOptions,  - input xml
    @SessionID OUTPUT - return value, id of the new session.
```

That is, the stored procedure for initiating a tuning session (here named sp_dta_add_session although it will be appreciated that the stored procedure may be known by any suitable name) may receive a session name (here described as a character sting of up to 30 characters, although any suitable session name may be used). The stored procedure may also receive tuning options. In some embodiments the tuning options may be presented in XML or in any other suitable language. The procedure may return a session identification code by which the session may be identified.

In some embodiments of the invention, sp_dta_add_session may be used to clone a session. When a session is cloned, all input information, (e.g., tuning parameters and so on as described above), from an existing session is retrieved, an internal copy of the input information is created in memory and the internal memory copy is submitted to initiate a new session. In some embodiments of the invention, the stored procedure sp_DTA_help_session is used to retrieve the parameters.

A stored procedure for updating a session may be:

| sp_dta_update_session | |
|---|---|
| @SessionID, | - ID of a session to update |
| [@SessionName,] | - New session name (optional) |
| [@TuningOptions,] | - New session tuning options (optional) |
| [@Status] | - New session status (optional) |

```
            Possible values:
            0 - stop session
            1 - cancel session
            2 - start session
```

That is, a stored procedure for updating a tuning session may be named sp_dta_update_session although it will be appreciated that any suitable name may be selected for the procedure. This stored procedure may enable the session name, tuning options or status of an existing session to be changed. In some embodiments of the invention, the procedure may receive an identification code identifying the session to be updated. Providing an (optional) new session name may indicate that the identified session is to be renamed with the provided new session name. In some embodiments of the invention, a new or modified set of tuning options may be provided using the new session tuning options option. The status of a session may be changed via the new session status option. As indicated above, in some embodiments of the invention a session status of “0” indicates that the identified session is to be stopped, a session status of“1” indicates that the identified session is to be cancelled and a session status of “2” indicates that the identified session is to be started.

A stored procedure for deleting a session may be:

sp_dta_delete_session
@SessionID - ID of a session to delete

As described above, in some embodiments, deleting a session stops the execution of the session and may remove all references to that session from all tables.

A stored procedure for retrieving session results may be:

sp_dta_get_session_tuning_results
@SessionID - ID of a session requested

In some embodiments of the invention, the above stored procedure returns the following rowset:

TuningResults, FinishStatus, StopTime

for the requested session.

A stored procedure for retrieving a session report may be:

| sp_dta_get_session_report | |
|---|---|
| @SessionID, | - ID of a session requested |
| @ReportID, | - ID of a report requested |
| @ReportType | - report format: |
| | 0 - rowset |
| | 1 - XML |

In some embodiments of the invention, the above stored procedure returns a rowset or XML rowset that contains a single report for a requested session.

A stored procedure for retrieving detailed information about one or more tuning sessions may be:

sp_dta_help_session

| | |
|---|---|
| @SessionID | - ID of a session to list, optional |
| @IncludeTuningOptions | - flag that indicates that input XML |
| | Should be included in returned rowset. |

In some embodiments of the invention, if no session ID is provided, this stored procedure may return a rowset that lists all sessions on a server. Sessions may be ordered by SessionID and may be presented in descending or ascending order. The columns listed may include:

SessionID, SessionName, Status, CreationTime, StartTime, StopTime

In some embodiments of the invention, the TuningOptions column may be provided with an input XML if a flag (e.g., IncludeTuningoptions) is set to ‘TRUE’. This column may be added as the last column in a rowset.

When a session ID is provided, the above stored procedure in some embodiments returns three different rowsets for that one session:
1) 1^{st} rowset: as above, one row only;
2) 2^{nd} rowset: progress events for the session. The rowset may contain the following columns:
   ProgressEventID, TuningStage, WorkloadConsumption, EstImprovement, ProgressEventTime.
3) 3^{rd} rowset: maximum workload consumption so far:
   A rowset may include one or two rows with those columns:
   TuningStage, MaxWorkloadConsumption

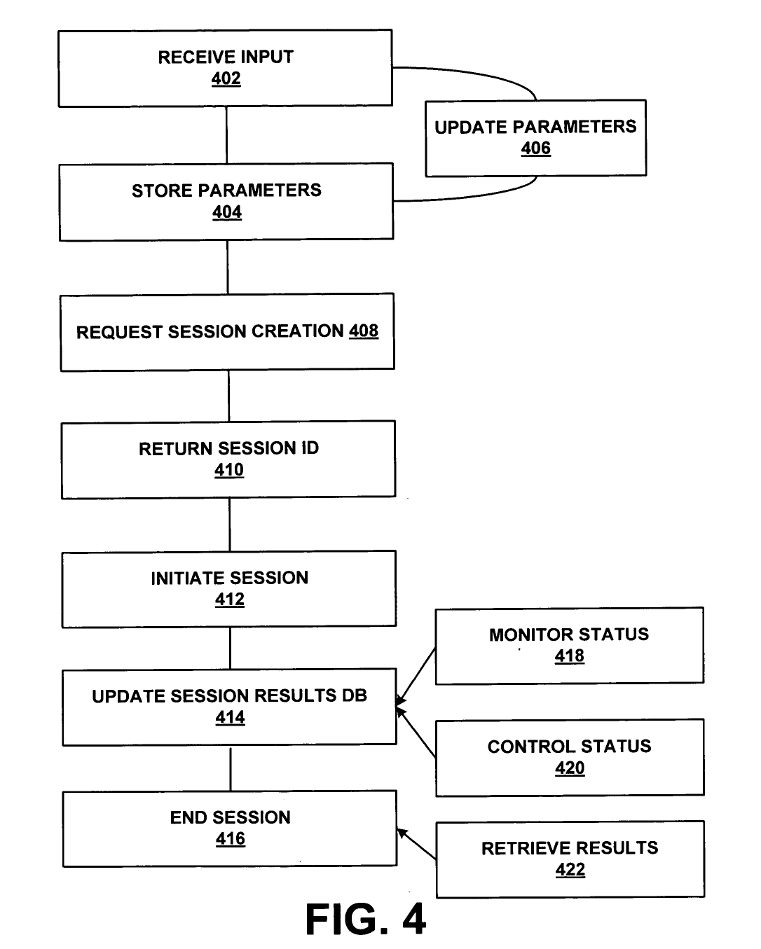

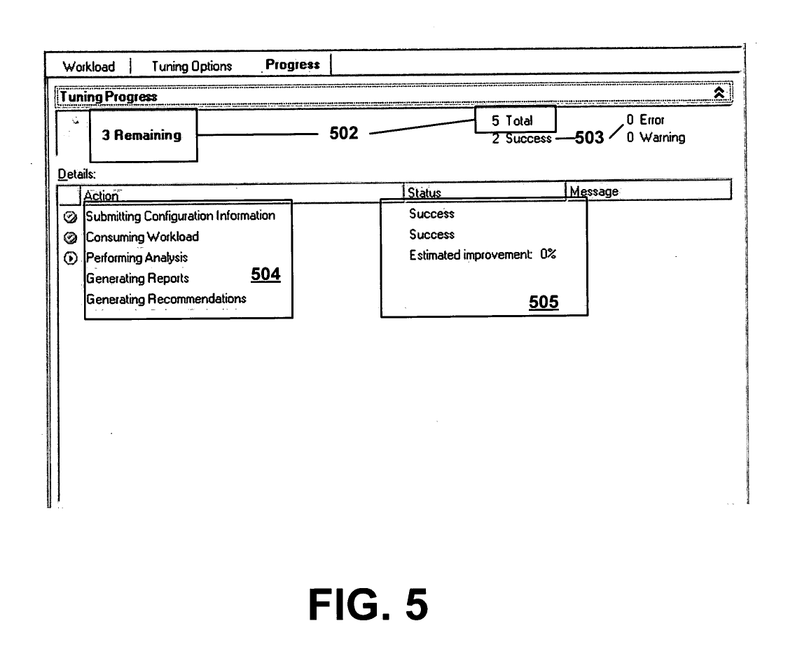

FIG. 4 is a flow diagram of an exemplary method for using the system of FIG. 3 in accordance with one embodiment of the invention. At 402 user input may be received. As described above, the user input may represent information associated with the tuning session, including configurations parameters. Some or all of this information may be stored in a database such as the tuning database of FIG. 3 (404). The information may be updated (in some embodiments by using the stored procedure “update”) one or more times (406). At 408 a request for initiation of the tuning session may be received. In some embodiments of the invention, a unique session identification code is generated (410). This unique session ID may be sent to the tuning engine, prompting the tuning engine to initiate a tuning session (412). As the tuning session executes, results may be generated and stored in a database (414). While the tuning session is executing, the status of the session may be monitored via the user interface (418). The progress of the session (displayed, for example, as a percentage completed), a graph displayed and the stages of the process tracked via the get session status stored procedure, as displayed in FIG. 5. The status of the session may be controlled (stop, cancel, delete) via the appropriate stored procedure (420). Upon completion or termination of the process (416), the results of the tuning session and the reports generated may be retrieved (422).

FIG. 5 illustrates an exemplary report of database tuning session progress showing tuning progress 502, status 503 (e.g., success, error, warning), actions 504 and status of the actions 505.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed is:

1. A system for tuning a database comprising:
a user interface that receives input comprising tuning parameters for a tuning session for at least one specified database and stores the tuning parameters in a tuning database;
a database tuning engine that receives the tuning parameters and initiates the tuning session for the at least one specified database and stores the results of the tuning session in the tuning database, wherein the user interface and the database tuning engine communicate via a stored procedure.

2. The system of claim 1, wherein the stored procedure comprises a procedure for initiating the tuning session.

3. The system of claim 2, wherein the stored procedure for initiating the tuning session receives a session name and a set of tuning options and returns an identification code for the tuning session.

4. The system of claim 3, wherein the set of tuning options are formatted in XML.

5. The system of claim 1, wherein the stored procedure comprises a procedure for updating the tuning session.

6. The system of claim 1, wherein tuning parameters associated with a first tuning session are copied and modified and a second tuning session is initiated using the modified tuning parameters.

7. The system of claim 1, wherein the stored procedure comprises a procedure for deleting the tuning session.

8. The system of claim 7, further comprising deleting the tuning parameters from the tuning database.

9. The system of claim 7, wherein the stored procedure for deleting the tuning session receives a session identification code and in response deletes the identified session.

10. The system of claim 1, wherein the stored procedure comprises a procedure for retrieving tuning results.

11. The system of claim 10, wherein the stored procedure for retrieving tuning results receives a session identification code and in response returns tuning results.

12. The system of claim 10, wherein the stored procedure for retrieving tuning results receives a session identification code and in response returns finish status.

13. The system of claim 10, wherein the stored procedure for retrieving tuning results receives a session identification code and in response returns stop time.

14. The system of claim 1, wherein the stored procedure comprises a stored procedure for retrieving a session report.

15. The system of claim 14, wherein the stored procedure for retrieving the session report receives an identification code for the tuning session and a report identification code for the report and returns the report in rowset format.

16. The system of claim 14, wherein the stored procedure for retrieving the session report receives an identification code for the tuning session and a report identification code for the report and returns the report in XML format.

17. A server for tuning a database in background, the server comprising a plurality of stored procedures for performing functions in response to a client request, wherein the functions comprise a first procedure that initiates a tuning session, a second procedure that monitors the tuning session and a third procedure that cancels the tuning session.

18. A method for tuning a database in background comprising:
receiving a request from a client to invoke one of a plurality of stored procedures comprising a procedure to initiate a tuning session in background, a procedure to monitor the session, a procedure to modify the session, a procedure to clone the session, a procedure to delete the session, a procedure to retrieve results of the tuning session or a procedure to retrieve reports for the tuning session.

19. A client for accessing a database tuning tool on a server, wherein the database tuning tool stores procedures for initiating a tuning session in background, monitoring the tuning session and canceling the tuning session, the client issuing a request for a procedure to be executed.

20. The client of claim 19, wherein in response to issuing a request for the tuning session to be initiated, a session identification code is generated and the tuning session is initiated.

21. The client of claim 19, wherein in response to issuing a request for the tuning session to be monitored, a tuning database stage of the monitored tuning session and an indication of portion of the tuning session completed is displayed.

22. The client of claim 19, wherein in response to issuing a request for a tuning session to be cancelled, the tuning session is terminated.

23. The client of claim 19, wherein in response to issuing a request for a tuning session to be deleted, the tuning session is terminated and configuration parameters stored in a tuning database are removed and results for the tuning session stored in the tuning database are removed.

24. A computer-readable medium comprising computer-executable instructions for a plurality of stored procedures comprising a procedure to initiate a database tuning session in background, a procedure to monitor the database tuning session, a procedure to modify the session, a procedure to clone the database tuning session, a procedure to delete the database tuning session, a procedure to retrieve results of the database tuning session or a procedure to retrieve reports for the database tuning session
